(19) United States
(12) Patent Application Publication
(10) Pub. No.: US 2026/0249293 A1
(43) Pub. Date: Aug. 27, 2026

(54) MICROFLUIDIC CHIP APPARATUS AND MICROFLUIDIC PROCESSING SYSTEM

(71) Applicant: NATIONAL YANG MING CHIAO TUNG UNIVERSITY, Hsinchu city (TW)

(72) Inventors: CHEN-YI LEE, Hsinchu city (TW); EUGENE EU TZUAN LEE, Hsinchu city (TW); CHENG HSUAN HSIEH, Hsinchu city (TW)

(21) Appl. No.: 19/087,779

(22) Filed: Mar. 24, 2025

(30) Foreign Application Priority Data
Feb. 27, 2025 (TW) 114107485

(51) Int. Cl. B01L 3/00

(52) U.S. Cl. CPC B01L 3/502753; B01L 2200/0689; B01L 2200/14; B01L 2300/0645

(57) ABSTRACT

A microfluidic chip apparatus includes a casing, a circuit board, a conductive foam gasket disposed above the circuit board, and a microfluidic chip disposed above the conductive foam gasket. The casing has at least one injection track. The microfluidic chip includes a top plate formed of a conductive material and a microelectrode dot array disposed below the top plate, wherein a space is defined between the top plate and the microelectrode dot array. The conductive foam gasket and top plate extend beyond at least one side of the microelectrode dot array and contact each other. The at least one injection track is connected to the space so that at least one droplet can be injected into the space through the at least one injection track. The microfluidic processing system includes the microfluidic chip apparatus and a control apparatus.

### CROSS REFERENCE TO RELATED APPLICATIONS AND CLAIM OF PRIORITY

This application claims the benefit under 35 USC § 119(a) of Taiwan Patent Application No. 114107485 filed on Feb. 27, 2025, in the Taiwan Intellectual Property Office, the entire disclosure of which is incorporated herein by reference for all purposes.

### BACKGROUND

### 1. Field of the Invention

The present invention relates to a microfluidic chip apparatus and a microfluidic processing system. More specifically, the present invention relates to a microfluidic chip apparatus and a microfluidic processing system that adopt real-time sensing technique and droplets stabilization technique.

### 2. Background of the Invention

Compared with conventional biomedical equipment, adopting digital microfluidic biochips (DMFB) in biomedical tests (e.g., protein analysis, disease diagnosis) offers several advantages, including equipment miniaturization, reaction volume reduction, low sample and reagent consumption, low cost, and clinical laboratory automation. In particular, DMFBs with microelectrode arrays can achieve good analytical results in various biomedical tests, such as nucleic acid-based tests and drug screening applications. DMFBs adopt electrowetting-on-dielectric (EWOD) technique to realize microfluidic operations, allowing automation of biomedical tests conventionally performed in laboratories. Currently, there are DMFBs customized for target-specific biomedical test as well as DMFBs and related systems adaptive to a variety of biomedical tests.

Regardless of the type of DMFB used for biomedical tests, the volume of droplets (e.g., test samples, reagents, buffers) injected into the DMFB must be precisely controlled in order to obtain accurate test results. However, conventional droplet injection techniques face two difficulties. First, it is commonly that a user manually injects droplet(s) into a DMFB by using an injection apparatus (e.g., a syringe), which, however, highly relies on the experience of the user. Therefore, it is often the case that volumes of droplets injected by different users are different so that accuracy of the subsequent biomedical test is affected. Second, the upper and lower surfaces of the space for accommodating the droplet(s) in the DMFB are usually hydrophobic, while the injection end of the injection apparatus (e.g., the needle) is hydrophilic. These characteristics increase the difficulty of separating droplet(s) from the injection apparatus and introducing them into the DMFB.

In view of this, there is an urgent need for a technique that can easily, stably, and precisely inject a required volume of droplets into a DMFB to improve the precision of injection and make the results of biomedical test more accurate.

### SUMMARY

An objective of the present invention is to provide a microfluidic chip apparatus, which includes a casing, a circuit board, a conductive foam gasket, and a microfluidic chip. The casing has at least one injection track. The conductive foam gasket is disposed above the circuit board. The microfluidic chip is disposed above the conductive foam gasket. The microfluidic chip includes a top plate and a microelectrode dot array, wherein the top plate is formed of a conductive material, the microelectrode dot array is disposed below the top plate, and a space is defined between the top plate and the microelectrode dot array. The conductive foam gasket and the top plate extend beyond at least one side of the microelectrode dot array and contact each other. The at least one injection track is connected to the space so that at least one droplet can be injected into the space through the at least one injection track.

In some embodiments, the microelectrode dot array includes a plurality of microelectrode devices connected in a series. Each of the microelectrode devices is configured to read a corresponding sample operation configuration during a first time interval. The conductive foam gasket is configured to conduct electricity during a second time interval to make the top plate have a predetermined voltage level. Each of the microelectrode devices is further configured to enter a corresponding sample operation status according to the corresponding sample operation configuration during the second time interval.

In some embodiments, the microelectrode devices are classified into belonging to an injection control zone and belonging to a non-injection control zone. The sample operation configurations read by the microelectrode devices belonging to the injection control zone make the microelectrode devices belonging to the injection control zone activate during the second time interval. The sample operation configurations read by the microelectrode devices belonging to the non-injection control zone make the microelectrode devices belonging to the non-injection control zone inactivate during the second time interval

In some embodiments, the injection control zone is neighboring to the at least one injection track.

In some embodiments, the microelectrode dot array includes a plurality of microelectrode devices connected in series. The microelectrode devices are configured to detect a plurality of capacitance values between the top plate and the microelectrode devices one-to-one during a first time interval, and the microelectrode devices are further configured to output the capacitance values in a plurality of sub-time intervals of a second time interval one-to-one.

Another objective of the present invention is to provide a microfluidic processing system. The microfluidic processing system includes a control apparatus and a microfluidic chip apparatus electrically connected to the control apparatus. The microfluidic chip apparatus includes a first casing, a first circuit board, a conductive foam gasket, and a microfluidic chip. The first casing has at least one injection track. The conductive foam gasket is disposed above the circuit board. The microfluidic chip is disposed above the conductive foam gasket and includes a top plate and a microfluidic dot array, wherein the top plate is formed of a conductive material, the microelectrode dot array is disposed below the top plate, and a space is defined between the top plate and the microfluidic dot array. The conductive foam gasket and the top plate extend beyond at least one side of the microelectrode dot array and contact each other. The at least one injection track is connected to the space so that at least one droplet can be injected into the space through the at least one injection track.

In some embodiments, the microelectrode dot array includes a plurality of microelectrode devices connected in a series. The control apparatus is configured to provide a plurality of sample operation configurations during a first time interval, and the microelectrode devices are configured to read the sample operation configurations one-to-one during the first time interval. The conductive foam gasket is configured to conduct electricity during a second time interval to make the top plate have a predetermined voltage level, and each of the microelectrode devices is further configured to enter a sample operation status according to the corresponding sample operation configuration during the second time interval.

In some embodiments, the microelectrode devices are classified into belonging to an injection control zone and belonging to a non-injection control zone. The sample operation configurations read by the microelectrode devices belonging to the injection control zone make the microelectrode devices belonging to the injection control zone activate during the second time interval. The sample operation configurations read by the microelectrode devices belonging to the non-injection control zone make the microelectrode devices belonging to the non-injection control zone inactivate during the second time interval.

In some embodiments, the injection control zone is neighboring to the at least one injection track.

In some embodiments, the microelectrode devices are configured to detect a plurality of capacitance values between the top plate and the microelectrode devices one-to-one during a first time interval, and the microelectrode devices are further configured to output the capacitance values in a plurality of sub-time intervals of a second time interval one-to-one.

In some embodiments, the control apparatus is further configured to determine a size and a location of each of the at least one droplet between the top plate and the microelectrode dot array according to the capacitance values.

In some embodiments, the control apparatus is further configured to transmit the capacitance values to a calculation apparatus so that the calculation apparatus determines a size and a location of each of the at least one droplet between the top plate and the microelectrode dot array according to the capacitance values.

In some embodiments, the microfluidic processing system further includes a second circuit board and a second casing. The second circuit board is electrically connected to the control apparatus and the microfluidic chip apparatus. The second casing is configured to accommodate the control apparatus and the second circuit board.

The detailed technology and preferred embodiments implemented for the subject invention are described in the following paragraphs accompanying the appended drawings for a person having ordinary skill in the art to well appreciate the features of the claimed invention.

### BRIEF DESCRIPTION OF THE DRAWINGS

FIG. 1A illustrates a lateral cross-sectional view of a microfluidic chip apparatus in some embodiments.

FIG. 1B illustrates a lateral cross-sectional view of a microfluidic chip apparatus in some other embodiments.

FIG. 1C illustrates a top perspective view of a microfluidic chip apparatus in yet some other embodiments.

FIG. 1D illustrates an exploded view of the microfluidic chip apparatus of FIG. 1C.

FIG. 1E illustrates a partial cross-sectional view of the microfluidic chip apparatus shown in FIG. 1C taken along the line I-I.

FIG. 2A illustrates a lateral view of a microfluidic chip in some embodiments.

FIG. 2B illustrates a top view of a microfluidic chip in some embodiments.

FIG. 2C illustrates a circuit block diagram of a microelectrode device in some embodiments.

FIG. 2D illustrates a top view of a microfluidic chip in some other embodiments.

FIG. 2E illustrates a circuit block diagram of a microelectrode device in some other embodiments.

FIG. 3 illustrates a schematic diagram of the architecture of a microfluidic processing system in some embodiments.

FIG. 4A illustrates an example of presenting sample operating configurations by a sample control pattern.

FIG. 4B illustrates an exemplary timing diagram.

FIG. 4C illustrates a schematic diagram of an exemplary injection control zone and non-injection control zone.

FIG. 5 illustrates a schematic diagram of a miniaturized microfluidic processing system in some embodiments.

### DETAILED DESCRIPTION

In the following descriptions, the microfluidic chip apparatus and microfluidic processing system provided by the present invention will be explained with reference to certain embodiments thereof. However, these embodiments are not intended to limit the present invention to any specific environment, application, or implementations described in these embodiments. In addition, the specific features, structures, and/or characteristics described in these embodiments may be combined in any suitable combination and/or sub-combination without departing from the spirit of the present invention. Therefore, descriptions of these embodiments are for the purpose of illustration rather than to limit the scope of the present invention. It should be noted that elements unrelated to the present invention are omitted from depiction in the following embodiments and the attached drawings. In addition, dimensions of elements and dimension scales between individual elements in the attached drawings are provided only for ease of depiction and illustration but not to limit the scope of the present invention. Furthermore, unless otherwise specified, the terms “a,” “the,” and similar terms used in this specification and the claims should be understood to include both singular and plural forms.

### Hardware Architecture of Microfluidic Chip Apparatus

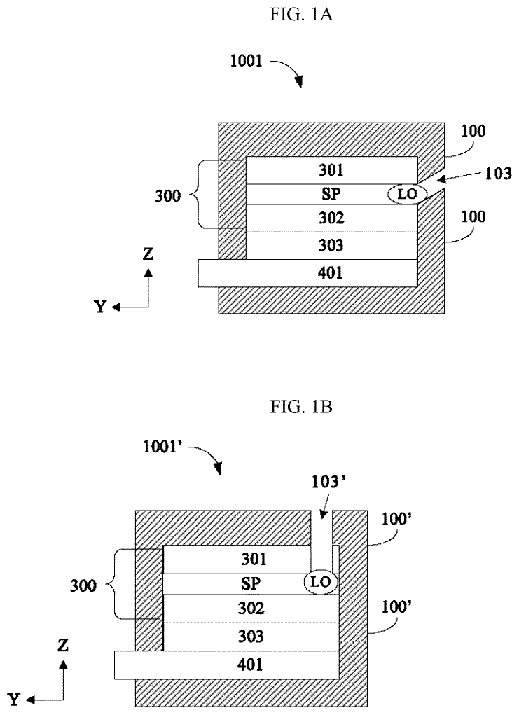

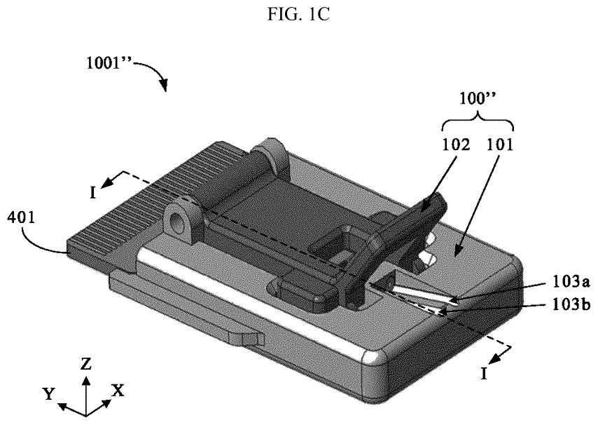

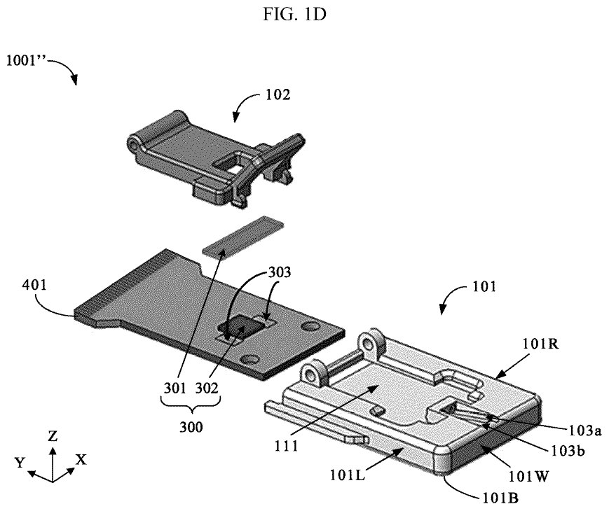

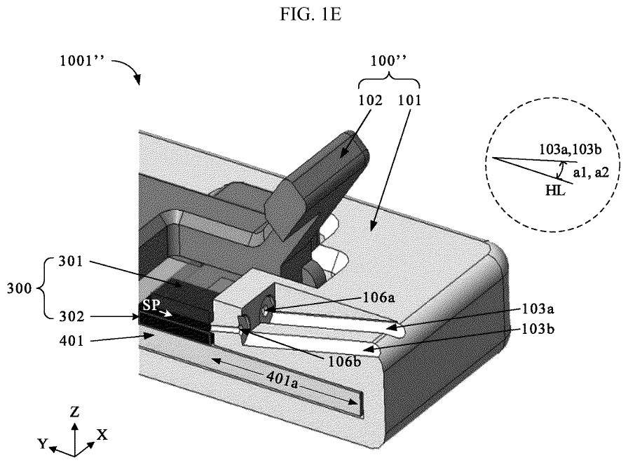

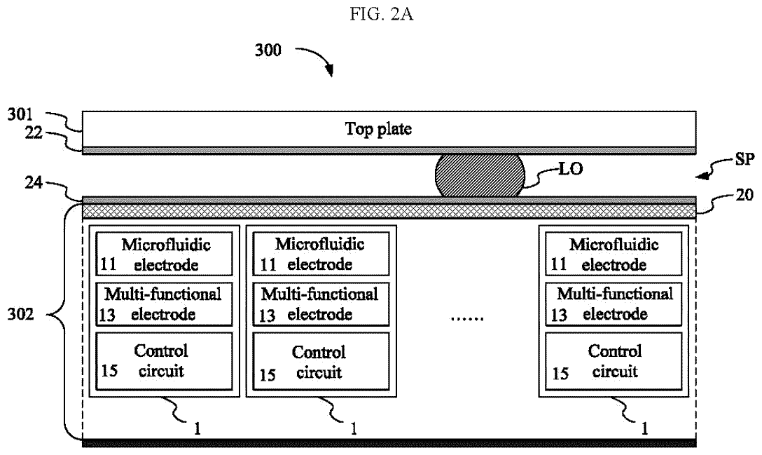

FIG. 1A illustrates a schematic lateral cross-sectional view of a microfluidic chip apparatus 1001 in some embodiments of the present invention. The microfluidic chip apparatus 1001 includes a casing 100, a circuit board 401, a conductive foam gasket 303, and a microfluidic chip 300, wherein the conductive foam gasket 303 is configured to be disposed above the circuit board 401, and the microfluidic chip 300 is configured to be disposed above the conductive foam gasket 303.

The microfluidic chip 300 includes a top plate 301 and a microelectrode dot array 302, wherein the microelectrode dot array 302 is disposed below the top plate 301, and a space SP is defined between the top plate 301 and the microelectrode dot array 302. The top plate 301 is formed of a conductive material (e.g., Indium Tin Oxide, ITO) and the conductive foam gasket 303 and the top plate 301 extend beyond at least one side of the microelectrode dot array 302 and contact each other. Thus, when the conductive foam gasket 303 conducts electricity, the top plate 301 will have a predetermined voltage level to generate sufficient force to stabilize or drive droplet(s) in the space SP by electrowetting-on-dielectric (EWOD) technique (will be described later).

Furthermore, the casing 100 has an injection track 103, and the injection track 103 is connected to the space SP. Therefore, at least one droplet LO can be injected into the space SP through the injection track 103 and move in the space SP. By providing the injection track 103 on the casing 100, a user can easily and stably inject the droplet LO into the space SP. It should be noted that although only one injection track is shown in FIG. 1A, the number of injection tracks provided on the casing is not limited in the present invention as long as there is at least one injection track on the casing.

FIG. 1B illustrates a schematic lateral cross-sectional view of a microfluidic chip apparatus 1001′ in some other embodiments of the present invention. The microfluidic chip apparatus 1001′ includes a casing 100′, a circuit board 401, a conductive foam gasket 303, and a microfluidic chip 300, wherein the conductive foam gasket 303 is configured to be disposed above the circuit board 401, and the microfluidic chip 300 is configured to be disposed above the conductive foam gasket 303.

The major difference between the microfluidic chip apparatus 1001′ shown in FIG. 1B and the microfluidic chip apparatus 1001 shown in FIG. 1A lies in the arrangement of the injection track on the casing. In FIG. 1B, the top plate 301 has a hole and, in line with this configuration, the casing 100′ has an injection track 103′ on top of the hole and the injection track 103′ is connected to the space SP. With this configuration, a user can easily and stably inject the droplet LO into the space SP since the injection tack 103′ is connected to the space SP. It should be noted that although only one injection track (i.e., formed by a hole of the top plate and an injection track on top of the hole) is shown in FIG. 1B, the number of injection tracks provided on the casing is not limited in the present invention as long as there is at least one injection track.

FIG. 1C to FIG. 1E illustrate schematic views of a microfluidic chip apparatus 1001″ in some embodiments of the present invention, wherein FIG. 1C is a top perspective view of the microfluidic chip apparatus 1001″, FIG. 1D is an exploded view of the microfluidic chip apparatus 1000″, and FIG. 1E is a partial cross-sectional view of the microfluidic chip apparatus 1000″ taken along the line I-I shown in FIG. 1C.

The microfluidic chip apparatus 1001″ includes a casing 100″, a circuit board 401, a conductive foam gasket 303, and a microfluidic chip 300, wherein the conductive foam gasket 303 is configured to be disposed above the circuit board 401, and the microfluidic chip 300 is configured to be disposed above the conductive foam gasket 303. In addition, the casing 100″ has two injection tracks 103a, 103b.

The casing 100″ of the embodiments shown in FIG. 1C to FIG. 1E includes a base 101 and a cover 102. The cover 102 can secure the microfluidic chip 300 from the top of the top plate 301. The base 101 has a bottom 101B and three walls 101L, 101W, 101R. The bottom 101B and the three walls 101L, 101W, 101R define an accommodation area 111, and at least a portion of the circuit board 401 can be embedded into the accommodation area 111. The injection tracks are provided on the wall 101W in the embodiments shown in FIG. 1C to FIG. 1E. When at least a portion of the circuit board 401 is embedded into the accommodation area 111 of the base 101, the injection tracks 103a and 103b are connected to the space SP. Therefore, at least one droplet can be injected into the space SP through the injection track 103a and/or the injection track 103b.

In some embodiments, when at least a portion of the circuit board 401 is embedded into the accommodation area 111, one side of the microfluidic chip 300 abuts against the inner side of the wall 101W having the injection tracks 103a and 103b so that the injection tracks 103a and 103b are right adjacent to the space SP and, hence, the droplet injected into the space will not spill outside the microfluidic chip 300.

In some embodiments, the injection track 103a forms a non-zero angle a1 with a horizontal axis HL, and the injection track 103b forms a non-zero angle a2 with the horizontal axis HL (as shown in the dotted circle in FIG. 1E). Since having the injection tracks 103a and 103b tilted with respect to the horizontal axis HL is more similar to a user tilting an injection apparatus for injection, a user can operate an injection apparatus more stably to make droplet(s) enter into the space SP more smoothly through the tilted injection track 103a and/or injection track 103b.

In some embodiments, the injection tracks 103a, 103b respectively have the injection channels 106a, 106b near the inner side of the wall 101W. The radius of the injection channel 106a is smaller than that of the injection track 103a, while the radius of the injection channel 106b is smaller than that of the injection track 103b. In these embodiments, when at least a portion of the circuit board 401 is embedded into the accommodation area 111 of the base 101, the injection channels 106a and 106b are right adjacent to the space SP defined by the top plate 301 and the microelectrode dot array 302 and are connected to the space SP. Thus, when using syringe(s) as the injection apparatus(es), the barrel(s) of the syringe(s) can be placed on the injection track 103a and/or the injection track 103b, and the needle(s) of the syringe(s) can be placed on the injection channel 106a and/or the injection channel 106b so that the injection apparatus become more stable and the droplet(s) can be injected into the space SP more smoothly.

In some embodiments, the accommodation area 111 extends to the lower portion of the wall 101W, and the extended area is located below the injection tracks 103a, 103b. In these embodiments, when at least a portion of the circuit board 401 is embedded into the accommodation area 111 of the base 101, a portion 401a of the circuit board 401 is embedded into the extended area and one side of the microfluidic chip 300 abuts against the inner side of the wall 101W having the injection tracks 103a, 103b. In this way, the microfluidic chip 300, the conductive foam gasket 303, and the circuit board 401 will be more stable so that the injected droplet(s) will not to spill outside the microfluidic chip 300.

### Architecture of Microfluidic Chip

The following description will be continued with reference to the microfluidic chip apparatus 1001; however, it is noted that the following description also applies to the microfluidic chip apparatus 1001′, the microfluidic chip apparatus 1001″, and other microfluidic chip apparatus that conform to the spirit of the present invention.

In some embodiments, the microfluidic chip 300 included in the microfluidic chip apparatus 1001 has a specific structure so that the microfluidic chip apparatus 1001 can be used with a control apparatus and a calculation apparatus. Through the control of the calculation apparatus and the control apparatus, droplet(s) can be injected into the microfluidic chip 300 more easily, more stably, and more precisely (will be described in details later). Herein, the architecture of the microfluidic chip 300 in some embodiments is described.

In some embodiments, the microfluidic chip 300 may be the microfluidic chip disclosed in Taiwan Patent Application No. 112109315 filed on Mar. 14, 2023, which is hereby incorporated by reference in its entirety.

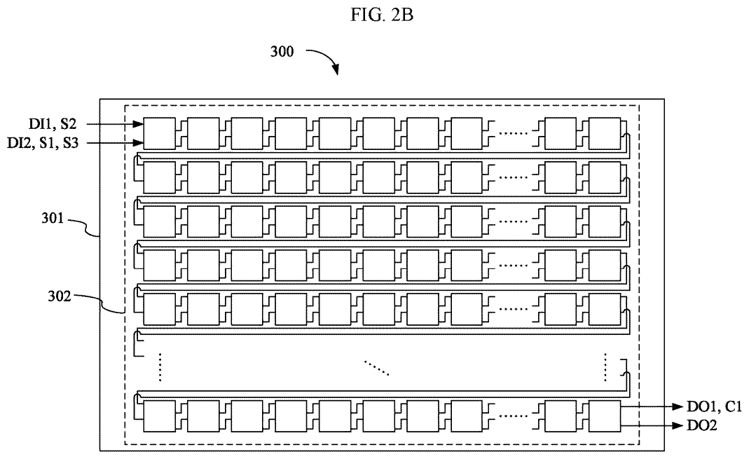

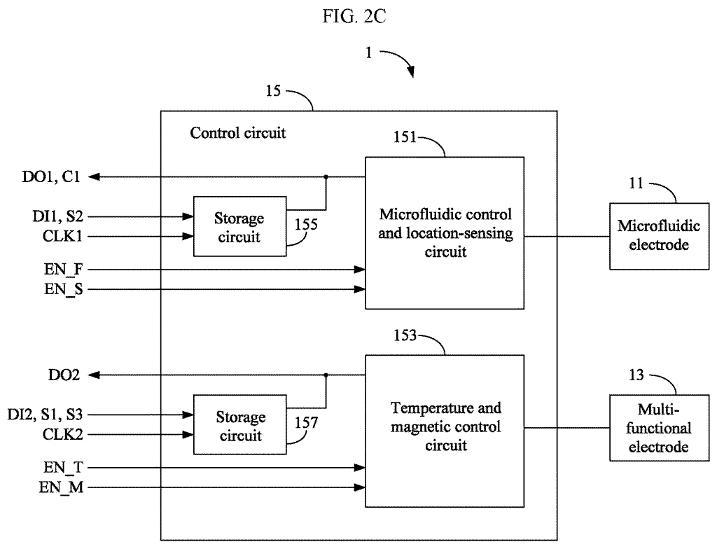

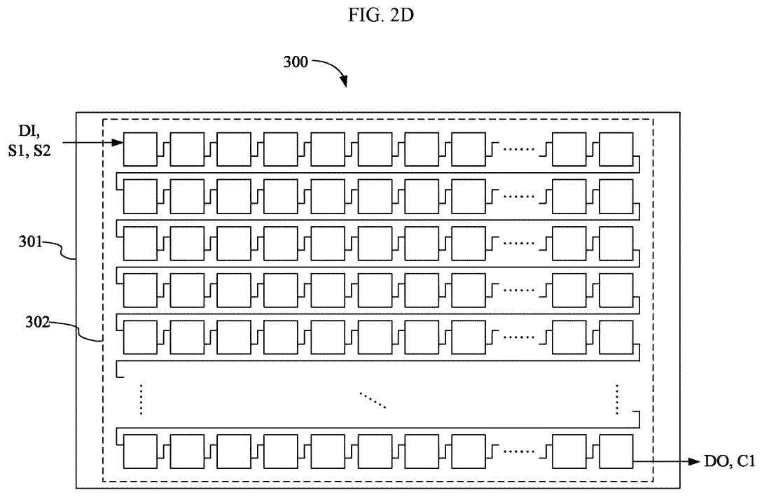

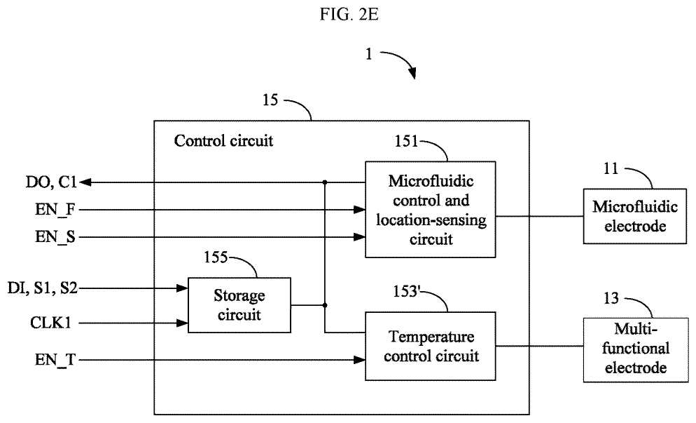

The lateral view and the top view of the microfluidic chip 300 in these embodiments are respectively shown in FIG. 2A and FIG. 2B. The microfluidic chip 300 includes a top plate 301 and a microelectrode dot array 302, wherein the microelectrode dot array 302 is disposed below the top plate 301, a space SP is defined between the top plate 301 and the microelectrode dot array 302, and at least one droplet LO can be injected into the space SP and be moved in the space SP. In some embodiments, the microfluidic chip 300 may further include two hydrophobic layers 22 and 24. The hydrophobic layer 22 is disposed below the top plate 301 and in direct contact with the top plate 301, while the hydrophobic layer 24 is disposed above the microelectrode dot array 302. The aforementioned space SP for the droplet(s) to be moved within can be defined by the hydrophobic layers 22 and 24. The hydrophobic layers 22 and 24 can be formed of hydrophobic material(s).

The microelectrode dot array 302 includes a plurality of microelectrode devices 1 connected in a series, wherein the microelectrode devices 1 are arranged in a two-dimensional array of the size p×q, and both p and q are positive integers greater than 1. The calculation apparatus also knows that the microelectrode devices 1 are arranged in a two-dimensional array of the size p×q. Each microelectrode device 1 includes a microfluidic electrode 11, a multi-functional electrode 13 (can be used as a heating electrode, an insulation layer, or a magnetic field providing layer depending on the operation being performed), and a control circuit 15. Each microfluidic electrode 11 is arranged under the top plate 301, each multi-functional electrode 13 is arranged under the corresponding microfluidic electrode 11 (i.e., the microfluidic electrode 11 belonging to the same microelectrode device 1), and each control circuit 15 is arranged under the corresponding multi-functional electrode 13 (i.e., the multi-functional electrode 13 belonging to the same microelectrode device 1). In some embodiments, the microelectrode dot array 301 may further include a microelectrode interface 20 arranged above the microelectrode devices 1 and below the hydrophobic layers 24. The microelectrode interface 20 is used for interfacing the hydrophobic layer 24 and can be a SiO₂ insulation layer.

The size of each microelectrode device 1 is not limited to any specific size in the present invention. Nevertheless, in some embodiments, the area of the top surface of each microelectrode device 1 can be 2,500 μm². Please also note that the distance between any two neighboring microelectrode devices 1 is not limited to any specific distance in the present invention. In some embodiments, the distance between a microelectrode device 1 and its neighboring microelectrode device 1 can be 1 μm.

In FIG. 2B, each square represents a microelectrode device 1, wherein each of the microelectrode devices 1 has two input terminals (i.e., a first input terminal and a second input terminal) and two output terminals (i.e., a first output terminal and a second output terminal). The microelectrode devices 1 are connected in series in terms of having a first input/output chain and having a second input/output chain. For each of the microelectrode devices 1 except the first microelectrode device 1, the first input terminal is coupled to the first output terminal of the previous microelectrode device 1 to form the first input/output chain. In this way, each of the microelectrode devices 1 except the first microelectrode device 1 receives the input signal DI1 (e.g., sample operation configuration S2) through the microelectrode device(s) 1 arranged ahead, and each of the microelectrode devices 1 except the last microelectrode device 1 provides the output signal DO1 (e.g., the stored capacitance value C1) through the microelectrode device(s) 1 arranged behind. Likewise, for each of the microelectrode devices 1 except the first microelectrode device 1, the second input terminal is coupled to the second output terminal of the previous microelectrode devices 1 to form the second input/output chain. In this way, each of the microelectrode devices 1 except the first microelectrode device 1 receives the input signal DI2 (e.g., heating control configuration S1, magnetic control configuration S3) through the microelectrode device(s) 1 arranged ahead, and each of the microelectrode devices 1 except the last microelectrode device 1 provides the output signal DO2 (e.g., the stored capacitance value) through the microelectrode device(s) 1 arranged behind.

In these embodiments, the circuit block diagram of each microelectrode device 1 may be the one shown in FIG. 2C. Each microelectrode device 1 includes a microfluidic electrode 11, a multi-functional electrode 13, and a control circuit 15. The control circuit 15 of each microelectrode device 1 includes a microfluidic control and location-sensing circuit 151, a temperature and magnetic control circuit 153, and two storage circuits 155 and 157. In each microelectrode device 1, the microfluidic control and location-sensing circuit 151 is coupled to the microfluidic electrode 11 and the storage circuit 155, and the temperature and magnetic control circuit 153 is coupled to the multi-functional electrode 13 and the storage circuit 157. For each microelectrode device 1, the aforementioned first input terminal and the aforementioned first output terminal are of the storage circuit 155, and the aforementioned second input terminal and the aforementioned second output terminal are of the storage circuit 157. It means that the aforementioned first input/output chain is formed by connecting the storage circuits 155, and the aforementioned second input/output chain is formed by connecting the storage circuits 157.

Each microfluidic control and location-sensing circuit 151 may receive a sample control signal (also called microfluidic control signal) EN_F and perform sample operation on the droplet(s) according to the sample control signal EN_F as well as receive a location-sensing signal EN_S and sense the capacitance value between the top plate 301 and microelectrode device 1 according to the location-sensing signal EN_S. Each storage circuit 155 may receive a clock signal CLK1 and receive and store an input signal DI1 (e.g., sample operation configuration S2) according to the clock signal CLK1 and/or provide an output signal DO1 (e.g., the stored capacitance value C1) according to the clock signal CLK1. Each temperature and magnetic control circuit 153 may receive a heating control signal EN_T and enable the multi-functional electrode 13 to function as a heating electrode according to heating control signal EN_T as well as receive a magnetic control signal EN_M and enable the multi-functional electrode 13 to function as a magnetic field providing layer according to the magnetic control signal EN_M. Each storage circuit 157 may receive a clock signal CLK2 and receive and store an input signal DI2 (e.g., heating control configuration S1, magnetic control configuration S3) according to the clock signal CLK2 and/or provide an output signal DO2 (e.g., the stored capacitance value) according to the clock signal CLK2.

In some embodiments, the microfluidic chip 300 may be the microfluidic chip disclosed in Taiwan Patent Application No. 11011956 filed on May 28, 2021 or may be the microfluidic chip disclosed in Taiwan Patent Application No. 111101835 filed on Jan. 17, 2022, which are hereby incorporated by reference in their entireties.

The lateral view and the top view of the microfluidic chip 300 in these embodiments are respectively shown in FIG. 2A and FIG. 2D. Each square in FIG. 2D represents a microelectrode device 1. Compared with FIG. 2B, each microelectrode device 1 in FIG. 2D has one input terminal and one output terminal. For each of the microelectrode devices 1 except the first microelectrode device 1, the input terminal is coupled to the output terminal of the previous microelectrode device 1. In this way, each of the microelectrode devices 1 except the first microelectrode device 1 receives an input signal DI (e.g., heating control configuration S1, sample operation configuration S2) through the microelectrode device(s) 1 arranged ahead, and each of the microelectrode devices 1 except the last microelectrode device 1 provides an output signal DO (e.g., stored capacitance value C1) through the microelectrode device 1 arranged behind.

In these embodiments, the circuit block diagram of each microelectrode device 1 may be the one shown in FIG. 2E. Each microelectrode device 1 includes a microfluidic electrode 11, a multi-functional electrode 13, and a control circuit 15. The control circuit 15 of each microelectrode device 1 includes a microfluidic control and location-sensing circuit 151, a temperature control circuit 153″, and a storage circuits 155. Each microfluidic control and location-sensing circuit 151 is coupled to the corresponding microfluidic electrode 11 (i.e., the microfluidic electrode 11 belonging to the same microelectrode device 1), and each temperature control circuit 153′ is coupled to the corresponding multi-functional electrode 13 (i.e., the multi-functional electrode 13 belonging to the same microelectrode device 1). The microfluidic control and location-sensing circuit 151, the temperature control circuit 153′, and the storage circuit 155 of the same microelectrode device 1 are coupled to each other. Each microfluidic control and location-sensing circuit 151 may receive a sample control signal EN_F and perform sample operation on the droplet(s) according to the sample control signal EN_F as well as receive a location-sensing signal EN_S and sense the capacitance value between the top plate 301 and the microelectrode device 1 according to the location-sensing signal EN_S. Each storage circuit 155 may receive a clock signal CLK1 and receive and store an input signal DI (e.g., heating control configuration S1, sample operation configuration S2) according to the clock signal CLK1 and/or provide an output signal DO (e.g., the stored capacitance value C1) according to the clock signal CLK1. Each temperature control circuit 153′ may receive a heating control signal EN_T and enable the multi-functional electrode 13 to function as a heating electrode according to heating control signal EN_T.

### Microfluidic Processing System

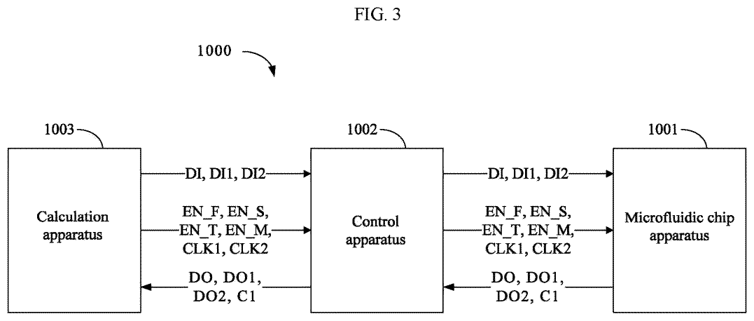

In some embodiments, the microfluidic chip apparatus 1001 may be used with a control apparatus 1002 and a calculation apparatus 1003 and serving as a microfluidic processing system 1000 together as shown in FIG. 3. Through the control of the control apparatus 1002 and the calculation apparatus 1003, the process of injecting droplet(s) into the microfluidic chip 300 will be easier, more stable, and more precise.

FIG. 3 illustrates a schematic diagram of the architecture of the microfluidic processing system 1000. The microfluidic processing system 1000 includes a microfluidic chip apparatus 1001, a control apparatus 1002, and a calculation apparatus 1003. The control apparatus 1002 may be a single-board computer, such as a Raspberry Pi. The calculation apparatus 1003 may be a smart mobile device, a laptop computer, a desktop computer, a server, or other computing devices known to those skilled in the art. The calculation apparatus 1003 is electrically connected to the control apparatus 1002, and the communication method(s) adopted therebetween may include one or more of the followings: wireless transmission techniques (e.g., Bluetooth, Wi-Fi), wired transmission techniques (e.g., transmission line), and other communication techniques or apparatuses known to those of ordinary skill in the art. The control apparatus 1002 is electrically connected to the microfluidic chip apparatus 1001, and the communication method(s) adopted therebetween may include one or more of the followings: wireless transmission techniques (e.g., Bluetooth, Wi-Fi), wired transmission techniques (e.g., transmission line), and other communication techniques or apparatuses known to those of ordinary skill in the art.

Next, among the operations performed by the microfluidic chip apparatus 1001, the control apparatus 1002, and the calculation apparatus 1003, those related to injecting droplet(s) stably are described.

### Apply Sample Operation(s) to Stabilize Droplet(s) in Microfluidic Chip

The calculation apparatus 1003 may control the microfluidic chip 300 through the control apparatus 1002 so that one or more sample operations can be applied to droplet(s) in the microfluidic chip 300 (e.g., stabilizing one or more droplets, moving one or more droplets, cutting droplets, mixing droplets). The following describes how to stabilize droplet(s) in the microfluidic chip 300 by applying sample operation(s).

The calculation apparatus 1003 may generate a plurality of sample operation configurations S2 according to a sample operation requirement (e.g., stabilizing droplet(s) at specified position(s)), wherein the sample operation configurations S2 correspond to the microelectrode devices 1 one-to-one. Each sample operation configuration will be read by the corresponding microelectrode device 1 (e.g., by the storage circuit 155 shown in FIG. 2C and FIG. 2E), and each sample operation is used to instruct the corresponding microelectrode device 1 (e.g., the microfluidic control and location-sensing circuit 151 shown in FIG. 2C and FIG. 2E) to enter a sample control status (i.e., activate or inactivate) corresponding to the sample operation configuration during a sample operation time interval.

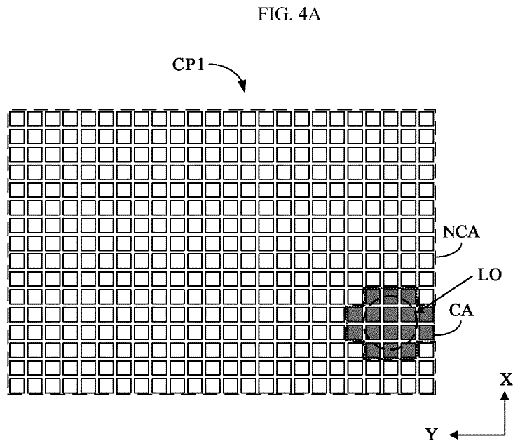

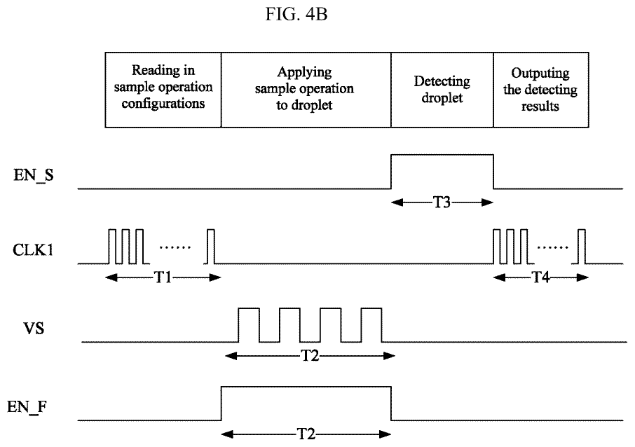

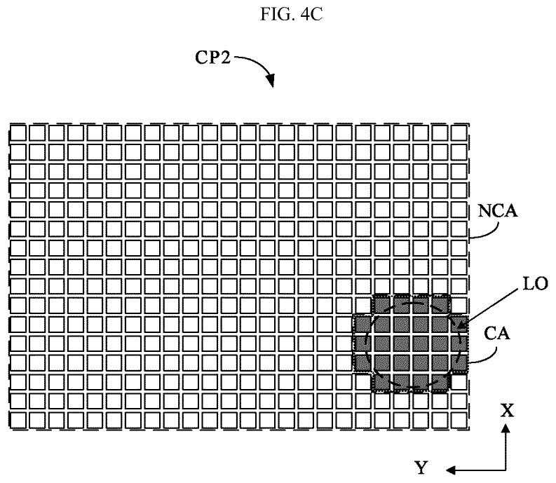

FIG. 4A demonstrates an example of presenting sample operation configurations S2 by a sample control pattern CP1, which, however is not intended to limit the scope of the present invention. In FIG. 4A, the p×q squares respectively represent the p×q sample operation configurations read by the p×q microelectrode devices 1 (e.g., read by the storage circuit 155 shown in FIG. 2C and FIG. 2E), wherein each grey square represents “activate” and each white square represent “inactivate.” For example, the sample operation configuration corresponding to a white square may be of the numerical value “0,” while the sample operation configuration corresponding to a grey square may be of numerical value “1.”

The calculation apparatus 1003 transmits the sample operation configurations S2 to the control apparatus 1002, and the control apparatus 1002 further provides the sample operation configurations S2 to the microfluidic chip 300. Please refer to an exemplary timing diagram shown in FIG. 4B, which, however, is not intend to limit the scope of the present invention. The clock signal CLK1 (provided to the microfluidic chip 300 from the calculation apparatus 1003 through the control apparatus 1002) is enabled within a plurality of sub-time intervals of a time interval T1 (e.g., the voltage level of the clock signal CLK1 can be high within the sub-time intervals of the time interval T1). The sub-time intervals of the time interval T1 correspond to the microelectrode devices 1 one-to-one. That is, the time interval T1 will have p×q sub-time intervals if the microelectrode dot array 302 includes p×q microelectrode devices 1. In this way, when the control apparatus 1002 provides the sample operation configurations S2 in the time interval T1, the microelectrode devices 1 will respectively read the corresponding sample operation configurations S2 in the sub-time intervals of the time interval T1. It is noted that the present invention does not restrict the clock rate of the clock signal CLK1 to any specific rate. For example, the control circuits 15 may read the sample operation configurations S2 under the setting that the clock rate of the clock signal CLK1 is 100 kHz.

The calculation apparatus 1003 provides a sample control signal EN_F to the microfluidic chip 300 via the control apparatus 1002, wherein the sample control signal EN_F is enabled within a time interval T2 (e.g., the voltage level of the sample control signal EN_F can be high within the time interval T2). The time interval T2 is after time interval T1. In addition, the conductive foam gasket 303 may receive a voltage signal VS, wherein the voltage signal VS has a predetermined voltage level during the time interval T2 to make the top plate 301 have the predetermined voltage level during the time interval T2. The time interval T2 is the aforementioned sample operation time interval. The sample control signal EN_F is enabled and the top plate 301 has the predetermined voltage level during the time interval T2. Therefore, each microelectrode device 1 will enter a sample operation status (i.e., activate or inactivate) during the time interval T2 according to the corresponding sample operation configuration. The activated microelectrode device(s) 1 will generate sufficient force under the effect of EWOD technique to attract droplet(s) so that the activated microelectrode device(s) 1 can stabilize the droplet(s) during the time interval T2.

Furthermore, in some embodiments, the aforementioned mechanism of applying sample operation(s) to stabilize droplet(s) in microfluidic chip may be implemented during the procedure of injecting droplet(s) into the microfluidic chip 300. In these embodiments, the microelectrode devices 1 are classified into belonging to an injection control zone CA and belonging to a non-injection control zone NCA, which means that the sample operation configurations S2 read by the microelectrode devices 1 are also classified into belonging to the injection control zone CA and belonging to the non-injection control zone NCA as show in FIG. 4A. In these embodiments, the injection control zone CA may be right adjacent to the at least one injection track on the wall (e.g., the injection track 103a and/or the injection track 103b).

In these embodiments, the sample operation configurations read by the microelectrode devices 1 corresponding to the injection control zone CA make the microelectrode devices 1 corresponding to the injection control zone CA activate during the time interval T2, while the sample operation configurations read by the microelectrode devices 1 corresponding to the non-injection control zone NCA make the microelectrode devices 1 corresponding to the non-injection control zone NCA inactivate during the time interval T2. As described above, the activated microelectrode devices 1 will generate sufficient force under the effect of EWOD technique to attract droplet(s). In this way, the activated microelectrode devices 1 can stabilize the droplet(s) in the injection control zone CA that is right adjacent to the injection track during the time interval T2.

### Positioning Droplet(s)

The microfluidic system 1000 can detect every droplet in the microfluidic chip 300 (specifically, in the space SP of the microfluidic chip 300) and position every droplet in the microfluidic chip 300 (i.e., determine the size and location of every droplet in the microfluidic chip 300). With the positioning mechanism, whether a droplet (or droplets) has/have been injected into the microfluidic chip 300 precisely can be determined if positioning the droplet(s) in the microfluidic chip 300 during the process of injecting the droplet(s).

Please continue to refer to the exemplary timing diagram shown in FIG. 4B. T calculation apparatus 1003 provides a location-sensing signal EN_S to the microfluidic chip 300 via the control apparatus 1002, wherein the location-sensing signal EN_S is enabled within a time interval T3 (e.g., the voltage level of the location-sensing signal EN_S can be high within the time interval T3). Since the location-sensing signal EN_S is enabled within the time interval T3, each microelectrode device 1 detects a capacitance value between the top plat 301 and itself during the time interval T3 (e.g., detecting by the microfluidic control and location-sensing circuit 151 shown in FIG. 2C and FIG. 2E). To be more specific, each microelectrode device 1 detect a capacitance value between the top plate 301 and its microfluidic electrode 11. The numerical value of each capacitance value C1 reflects whether there is any liquid between the top plate 301 and the corresponding microelectrode device 1 (to be more specific, between the top plate 301 and the corresponding microfluidic electrode 11). If using the numerical values “0” and “1” to indicate the detected capacitance values, the numerical value “1” may be used to indicate having liquid between the top plate 301 and the corresponding microelectrode device 1 (to be more specific, between the top plate 301 and the corresponding microfluidic electrode 11) and the numerical value “0” may be used to indicate no liquid between the top plate 301 and the corresponding microelectrode device 1 (to be more specific, between the top plate 301 and the corresponding microfluidic electrode 11).

In addition, the clock signal CLK1 provided by the calculation apparatus 1003 to the microfluidic chip 300 through the control apparatus 1002 is enabled within a plurality of sub-time intervals of a time interval T4 (e.g., the voltage level of the clock signal CLK1 can be high within the sub-time intervals of the time interval T4). The time interval T4 is after the time interval T3. The sub-time intervals of the time interval T4 correspond to the microelectrode devices 1 one-to-one. The time interval T4 will have p×q sub-time intervals if the microelectrode dot array 302 includes p×q microelectrode devices 1. Since the clock signal CLK1 is enabled during the sub-time intervals of the time interval T4, the microelectrode devices 1 will respectively output the capacitance values C1 during the sub-time intervals of the time interval T4 (e.g., output by the storage circuit 155 shown in FIG. 2C and FIG. 2E). The present invention does not restrict the clock rate of the clock signal CLK1 to any specific rate. For example, the control circuits 15 may output the capacitance values C1 under the setting that the clock rate of the clock signal CLK1 is 100 kHz.

The control apparatus 1002 receives the capacitance values C1 from the microfluidic chip 300 and transmits the capacitance values C1 to the calculation apparatus 1003. Since the calculation apparatus 1003 knows that the microelectrode devices 1 are arranged in a two-dimensional array of the size p×q and that the capacitance values C1 correspond to the microelectrode devices 1 one-to-one, the calculation apparatus 1003 can calculate the size and location of each droplet in the microfluidic chip 300 according to the capacitance values C1. In this way, the calculation apparatus 1003 can determine whether the droplet(s) has/have been injected into the microfluidic chip 300 precisely and can further decide whether to proceed with additional relevant control.

For ease of understanding, FIG. 4A also illustrates the size and location of the droplet determined by the calculation apparatus 1003 according to the capacitance values C1. It is clearly shown in FIG. 4A that the injected droplet LO is stabilized in the injection control zone CA right adjacent to the injection track.

### Real-Time Sensing and Feedback

In some embodiments, the calculation apparatus 1003 may store a protocol corresponding to a biomedical process, and the protocol may include the sample volume of a required sample, the reagent volume of a required reagent, and/or other requirement that a biomedical test has to follow.

In these embodiments, after calculating the size and location of the droplet LO according to the capacitance values C1, the calculation apparatus 1003 may further determine whether the volume of the droplet LO in the microfluidic chip 300 meets the requirement specified in the protocol that has to follow based on the size of the droplet LO (for example, if the droplet LO is a sample, determining whether its volume reaches the specified sample volume; as another example, if the droplet LO is a reagent, determining whether its volume reaches the specified reagent volume). If the volume of the droplet LO in the microfluidic chip 300 has conformed to the requirement specified in the protocol, the calculation apparatus 1003 may send a termination message to alert the user to stop injecting droplet into the space SP. On the contrary, if the calculation apparatus 1003 determines, based on the capacitance values C1, that the volume of the droplet LO in the microfluidic chip 300 has not reached the volume specified in the protocol, the calculation apparatus 1003 may send a prompt message to remind the user to continue injecting droplet into the space SP.

Furthermore, the calculation apparatus 1003 may adjust the injection control zone CA (e.g., enlarging the range of the injection control zone CA such as the sample control pattern CP2 shown in FIG. 4C), generate a plurality of sample operation configurations according to the adjusted injection control zone CA, and provide the adjusted sample operation configurations to the microfluidic chip 300 through the control apparatus 1002 to make the microfluidic chip 300 apply sample operation to the droplet LO according to the adjusted sample operation configurations. In this way, as the user continues injecting droplet into the space SP, the microfluidic chip 300 can stabilize the continuously injected droplet more precisely according to the adjusted sample operation configuration. Similarly, the microfluidic chip 300 may detect the capacitance values again and output the newly detected capacitance values so that the calculation apparatus 1003 may perform the aforementioned determination again. The aforementioned procedure may be repeated multiple times until the calculation apparatus 1003 determines that the volume of the droplet LO in the microfluidic chip 300 reaches the volume specified in the protocol. Based on the above descriptions, a person having ordinary skill in the art shall appreciate how the calculation apparatus 1003, the control apparatus 1002, and the microfluidic chip 300 operate repeatedly to make the volume of the droplet LO in the microfluidic chip 300 reaches the volume specified in the t protocol, hence the details are not further described.

### Some Other Embodiments of the Microfluidic Processing System

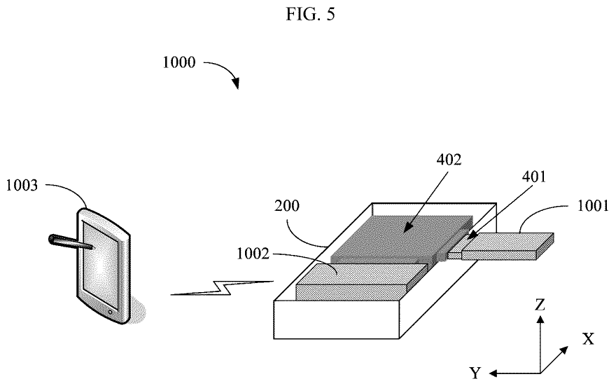

In some embodiments, the microfluidic processing system 1000 may be implemented as a miniature device that is convenient to carry as shown in FIG. 5. In these embodiments, the microfluidic system 1000 includes a microfluidic chip apparatus 1001, a control apparatus 1002, a calculation apparatus 1003, a circuit board 402, and a casing 200. The microfluidic chip apparatus 1001 is electrically connected to the control apparatus 1002 through the circuit board 402, and the control apparatus 1002 and the calculation apparatus 1003 communicate with each other wirelessly. Both the control apparatus 1002 and the circuit board 402 can be accommodated into the casing 200, forming a miniature device that is easy to carry.

In some embodiments, the microfluidic chip apparatus 1001 is detachably inserted into the circuit board 402. In this way, after the microfluidic chip apparatus 1001 has been used in a biomedical process, the microfluidic chip apparatus 1001 can be detached from the circuit board 402 and another microfluidic chip apparatus can be inserted into the circuit board 402 to perform another biomedical process.

In other embodiments, the microfluidic processing system of the present invention may adopt other configurations. For example, it is feasible to have two or more microfluidic chip apparatuses detachably inserted into the circuit board 402. As another example, it is also feasible to have two or more microfluidic chip apparatuses detachably inserted into two or more circuit board.

In some embodiments, the functions of the calculation apparatus 1003 and the control apparatus 1002 may be integrated into one control apparatus. Based on the above descriptions, a person having ordinary skill in the art can understand how a control apparatus that integrates all the functions of the calculation apparatus 1003 and the control apparatus 1002 cooperates with the microfluidic chip apparatus 1001, hence the details are not further described.

It shall be appreciated that, in the specification and the claims of the present application, some terms (including casing, circuit board, time interval) are preceded by the terms “first” or “second.” Please note that the terms “first” and “second” are used only for distinguishing different terms. If the order of these terms is not specified or the order of the terms cannot be derived from the context, the order of these terms is not limited by the preceded “first” or “second.”

According to the above descriptions, the microfluidic chip apparatus provided by the present invention has injection track(s) on its casing (e.g., on the wall of the base of the casing) so that the space of the microfluidic chip for accommodating droplet(s) is connected with the injection track(s). In this way, an injection apparatus can inject droplet(s) into the space of the microfluidic chip for accommodating droplet(s) through the injection track(s). As the injection apparatus can be placed on the injection track, it will become more stable during injection and, as a result, droplet(s) can be injected into the space more smoothly without damaging the microfluidic chip during injection. Furthermore, the microfluidic chip apparatus provided by the present invention may be used with a control apparatus or even further with a calculation apparatus and serving as a microfluidic processing system together. The calculation apparatus and/or the control apparatus classify the microelectrode devices of the microfluidic chip into belonging to an injection control zone (right adjacent to injection track(s)) and a non-injection control zone to make the microfluidic chip stabilize droplet(s) under the effect of the EWOD technique. Consequently, the microfluidic chip apparatus and microfluidic processing system provided by the present invention can control the volume of the droplet being injected into the microfluidic chip more easily, stably, and precisely and inject the droplet into the microfluidic chip apparatus with required volume to make the result of the biomedical test more accurate.

The above disclosure is related to the detailed technical contents and inventive features. A person having ordinary skill in the art may proceed with various modifications and replacements based on the disclosures and suggestions of the invention as described without departing from the characteristics thereof. Nevertheless, although such modifications and replacements are not fully disclosed in the above descriptions, they have been substantially covered in the following claims as appended.

What is claimed is:

1. A microfluidic chip apparatus comprising:
a casing having at least one injection track;
a circuit board;
a conductive foam gasket disposed above the circuit board; and
a microfluidic chip disposed above the conductive foam gasket, the microfluidic chip comprising:
a top plate formed of a conductive material; and
a microelectrode dot array disposed below the top plate, wherein a space is defined between the top plate and the microelectrode dot array;
wherein the conductive foam gasket and the top plate extend beyond at least one side of the microelectrode dot array and contact each other,
wherein the at least one injection track is connected to the space so that at least one droplet can be injected into the space through the at least one injection track.

2. The microfluidic chip apparatus of claim 1, wherein the microelectrode dot array comprises a plurality of microelectrode devices connected in a series, each of the microelectrode devices is configured to read a corresponding sample operation configuration during a first time interval, the conductive foam gasket is configured to conduct electricity during a second time interval to make the top plate have a predetermined voltage level, and each of the microelectrode devices is further configured to enter a corresponding sample operation status according to the corresponding sample operation configuration during the second time interval.

3. The microfluidic chip apparatus of claim 2, wherein the microelectrode devices are classified into belonging to an injection control zone and belonging to a non-injection control zone, the sample operation configurations read by the microelectrode devices belonging to the injection control zone make the microelectrode devices belonging to the injection control zone activate during the second time interval, and the sample operation configurations read by the microelectrode devices belonging to the non-injection control zone make the microelectrode devices belonging to the non-injection control zone inactivate during the second time interval.

4. The microfluidic chip apparatus of claim 3, wherein the injection control zone is neighboring to the at least one injection track.

5. The microfluidic chip apparatus of claim 1, wherein the microelectrode dot array comprises a plurality of microelectrode devices connected in a series, the microelectrode devices are configured to detect a plurality of capacitance values between the top plate and the microelectrode devices one-to-one during a first time interval, and the microelectrode devices are further configured to output the capacitance values in a plurality of sub-time intervals of a second time interval one-to-one.

6. A microfluidic processing system comprising:
a control apparatus; and
a microfluidic chip apparatus electrically connected to the control apparatus, the microfluidic chip apparatus comprising:
a first casing having at least one injection track;
a first circuit board;
a conductive foam gasket disposed above the circuit board; and
a microfluidic chip disposed above the conductive foam gasket, the microfluidic chip comprising a top plate and a microfluidic dot array, wherein the top plate is formed of a conductive material, the microelectrode dot array is disposed below the top plate, and a space is defined between the top plate and the microfluidic dot array;
wherein the conductive foam gasket and the top plate extend beyond at least one side of the microelectrode dot array and contact each other,
wherein the at least one injection track is connected to the space so that at least one droplet can be injected into the space through the at least one injection track.

7. The microfluidic processing system of claim 6, wherein the microelectrode dot array comprises a plurality of microelectrode devices connected in a series, the control apparatus is configured to provide a plurality of sample operation configurations during a first time interval, and the microelectrode devices are configured to read the sample operation configurations during the first time interval one-to-one,
wherein the conductive foam gasket is configured to conduct electricity during a second time interval to make the top plate have a predetermined voltage level, and each of the microelectrode devices is further configured to enter a sample operation status according to the corresponding sample operation configuration during the second time interval.

8. The microfluidic processing system of claim 7, wherein the microelectrode devices are classified into belonging to an injection control zone and belonging to a non-injection control zone, the sample operation configurations read by the microelectrode devices belonging to the injection control zone make the microelectrode devices belonging to the injection control zone activate during the second time interval, and the sample operation configurations read by the microelectrode devices belonging to the non-injection control zone make the microelectrode devices belonging to the non-injection control zone inactivate during the second time interval.

9. The microfluidic processing system of claim 8, wherein the injection control zone is neighboring to the at least one injection track.

10. The microfluidic processing system of claim 7, wherein the microelectrode devices are configured to detect a plurality of capacitance values between the top plate and the microelectrode devices one-to-one during a first time interval, and the microelectrode devices are further configured to output the capacitance values in a plurality of sub-time intervals of a second time interval one-to-one.

11. The microfluidic processing system of claim 10, wherein the control apparatus is further configured to determine a size and a location of each of the at least one droplet between the top plate and the microelectrode dot array according to the capacitance values.

12. The microfluidic processing system of claim 10, wherein the control apparatus is further configured to transmit the capacitance values to a calculation apparatus so that the calculation apparatus determines a size and a location of each of the at least one droplet between the top plate and the microelectrode dot array according to the capacitance values.

13. The microfluidic processing system of claim 6, further comprising:
a second circuit board electrically connected to the control apparatus and the microfluidic chip apparatus; and
a second casing configured to accommodate the control apparatus and the second circuit board.
